(19) United States
(12) Patent Application Publication
(10) Pub. No.: US 2025/0321597 A1
(43) Pub. Date: Oct. 16, 2025

(54) FLIGHT METHOD FOR MOVING BODY, FLIGHT SETTING DEVICE, AND NON-TRANSITORY COMPUTER READABLE MEDIUM STORING PROGRAM

(71) Applicant: SUMITOMO HEAVY INDUSTRIES CONSTRUCTION CRANES CO., LTD., Tokyo (JP)

(72) Inventors: Minoru TOIDA, Tokyo (JP); Katsuaki Kamashima, Tokyo (JP); Kazuomi Miyahara, Tokyo (JP); Yu Keda, Tokyo (JP)

(21) Appl. No.: 19/250,020

(22) Filed: Jun. 25, 2025

Related U.S. Application Data
(63) Continuation of application No. PCT/JP2023/046572, filed on Dec. 26, 2023.

(30) Foreign Application Priority Data
Dec. 27, 2022 (JP) 2022-209919

(51) Int. Cl. G05D 1/689; B66C 13/46; G05D 1/223; G05D 109/20

(52) U.S. Cl. CPC G05D 1/689; B66C 13/46; G05D 1/2232; G05D 2109/20

(57) ABSTRACT

A flight method for a moving body including a detection unit, the method includes: a first flight process of flying while the detection unit detects a surface of a normal portion other than a specific portion of a crane; and a second flight process of flying while the detection unit detects a surface of the specific portion of the crane in a state where at least one of a position, a turning angle, and a boom angle is different, compared to the first flight process.

### CROSS-REFERENCE TO RELATED APPLICATIONS

This is a bypass continuation of International PCT Application No. PCT/JP2023/046572, filed on Dec. 26, 2023, which claims priority to Japanese Patent Application No. 2022-209919, filed on Dec. 27, 2022, which are incorporated by reference herein in their entirety.

### BACKGROUND

### Technical Field

A certain embodiment of the present invention relates to a flight method for a moving body, a flight setting device, and a non-transitory computer readable medium storing a program.

### Description of Related Art

A work machine such as a crane requires various inspections for work safety.

In particular, as a device such as a crawler crane is enlarged, the requirement for safety is increased (for example, refer to the related art).

### SUMMARY

According to an aspect of the present invention, there is provided a flight method for a moving body including a detection unit. The flight method includes a first flight process of flying while the detection unit detects a surface of a normal portion other than a specific portion of a crane, and a second flight process of flying while the detection unit detects a surface of the specific portion of the crane in a state where at least one of a position, a turning angle, and a boom angle is different, compared to the first flight process.

In addition, according to another aspect of the present invention, there is provided a flight setting device for performing settings related to a flight of a moving body including a detection unit. The device includes a flight path setting unit that sets a flight path of the moving body, and an information transmission unit that transmits flight information for causing the moving body to fly along the flight path set by the flight path setting unit to the moving body. The flight path setting unit is configured to set the flight path for each region of a plurality of regions obtained by dividing a periphery of a crane.

In addition, according to still another aspect of the present invention, there is provided a non-transitory computer readable medium storing a program for performing settings related to a flight of a moving body including a detection unit. The program, when executed by a computer, causes the computer to execute a flight path setting step of setting a flight path of the moving body, and an information transmission step of transmitting flight information for causing the moving body to fly along the flight path set in the flight path setting step to the moving body. In the flight path setting step, the flight path is settable for each region of a plurality of regions obtained by dividing a periphery of a crane.

### BRIEF DESCRIPTION OF THE DRAWINGS

FIG. 1 is a schematic diagram for describing an inspection system for a crane according to an embodiment of the present invention.

FIG. 2 is a block diagram illustrating a control system of a moving body.

FIG. 3 is a side view of the crane.

FIG. 4 is a block diagram illustrating a control system of the crane.

FIG. 5 is a block diagram illustrating a configuration of a management server.

FIG. 6 is a block diagram illustrating a schematic control system of an information terminal.

FIG. 7 is a view illustrating an example of a crane disposed in a narrow work site.

FIG. 8 is a sectional view of a tower boom taken along line A-A in FIG. 7.

FIG. 9 is a flowchart illustrating a flow of a path setting process.

FIG. 10 is a flowchart illustrating a flow of the path setting process.

FIG. 11 is a view illustrating a flight path of the moving body on a first surface of the tower boom.

FIG. 12A is a view illustrating an example of an information setting screen in the path setting process.

FIG. 12B is a view illustrating an example of the information setting screen in the path setting process.

FIG. 13A is a view illustrating an example of a flight information setting screen of the moving body.

FIG. 13B is a view illustrating an example of the flight information setting screen of the moving body.

FIG. 14A is a view illustrating an example of the flight path setting screen of the moving body.

FIG. 14B is a view illustrating an example of the flight path setting screen of the moving body.

FIG. 14C is a view illustrating an example of the flight path setting screen of the moving body.

FIG. 14D is a view illustrating an example of the flight path setting screen of the moving body.

FIG. 14E is a view illustrating an example of the flight path setting screen of the moving body.

FIG. 15 is a view illustrating a flight path of the moving body on a third surface of the tower boom.

FIG. 16 is a view illustrating a flight path of the moving body on a fourth surface of the tower boom.

FIG. 17 is a view illustrating a flight path of the moving body on a second surface of the tower boom.

FIG. 18 is a view three-dimensionally illustrating an example obtained by synthesizing flight paths of the moving body on the first surface to the fourth surface of the tower boom.

FIG. 19A is a view schematically illustrating a modification example of a flight path of the moving body.

FIG. 19B is a view schematically illustrating a modification example of the flight path of the moving body.

FIG. 19C is a view schematically illustrating a modification example of the flight path of the moving body.

### DETAILED DESCRIPTION

Inspection work for a crane is carried out by using a moving body (for example, a drone). However, when a work site where the crane is disposed is narrow, the moving body cannot freely fly in some cases.

It is desirable to provide a flight method for a moving body, a flight setting device, and a non-transitory computer readable medium storing a program which can carry out inspection work for a crane by using a moving body even in a narrow work site.

Hereinafter, an embodiment according to the present invention will be described in detail with reference to the drawings.

### Outline of Crane Inspection System

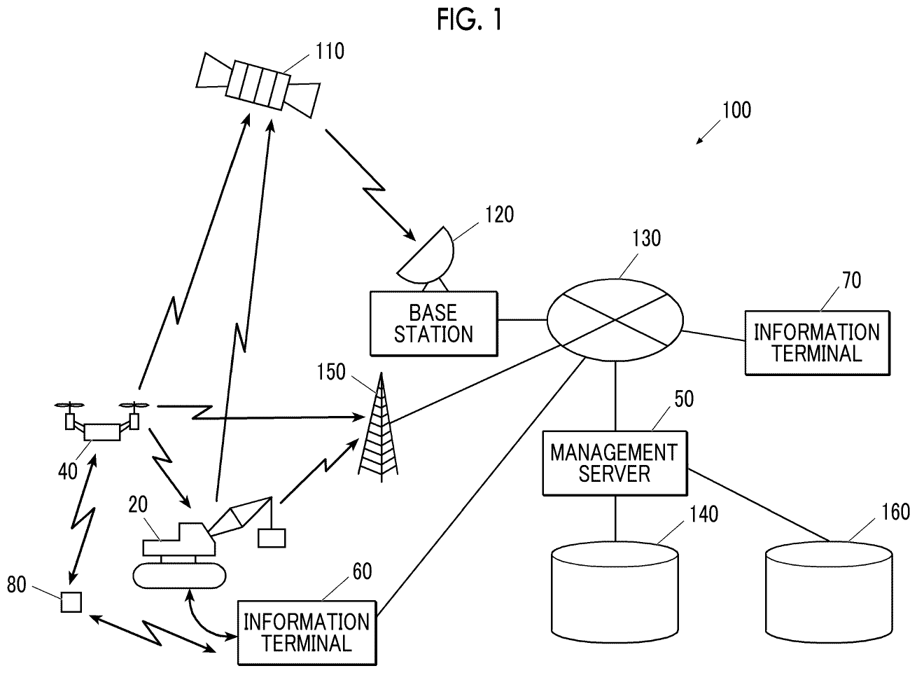

FIG. 1 is a view illustrating an outline of a crane inspection system (hereinafter, simply referred to as an “inspection system”) 100 according to an embodiment of the present invention.

As illustrated in FIG. 1, the inspection system 100 includes a crane 20 serving as an inspection target, a moving body 40 moving around the crane 20, information terminals 60 and 70 serving as processing units that perform predetermined processing on data acquired by the moving body 40, a management server 50, and a remote controller 80.

The management server 50 is connected to a network 130 serving as a general public line network.

In addition to the management server 50, base stations 120 and 150, the information terminals 60 and 70, and the like are connected to the network 130. The management server 50 can exchange data with nodes connected to the network 130, that is, the base stations 120 and 150, the moving body 40, and a plurality of the information terminals 60 and 70.

The remote controller 80 is configured to be capable of communicating with the moving body 40 and the information terminal 60, and mediates transmission and reception of information (for example, image information or the like acquired by the moving body 40) therebetween. In addition, the remote controller 80 is configured to be capable of controlling an operation of the moving body 40, and, for example, the moving body 40 can be manually operated.

The base station 120 is a base station of a satellite communication line which can transmit and receive radio waves via a satellite 110, and the base station 150 is a base station of a so-called mobile phone communication line.

When the base stations 120 and 150 receive various data from the moving body 40, the crane 20, or the like, the base stations 120 and 150 transmit various data to the management server 50 via the network 130.

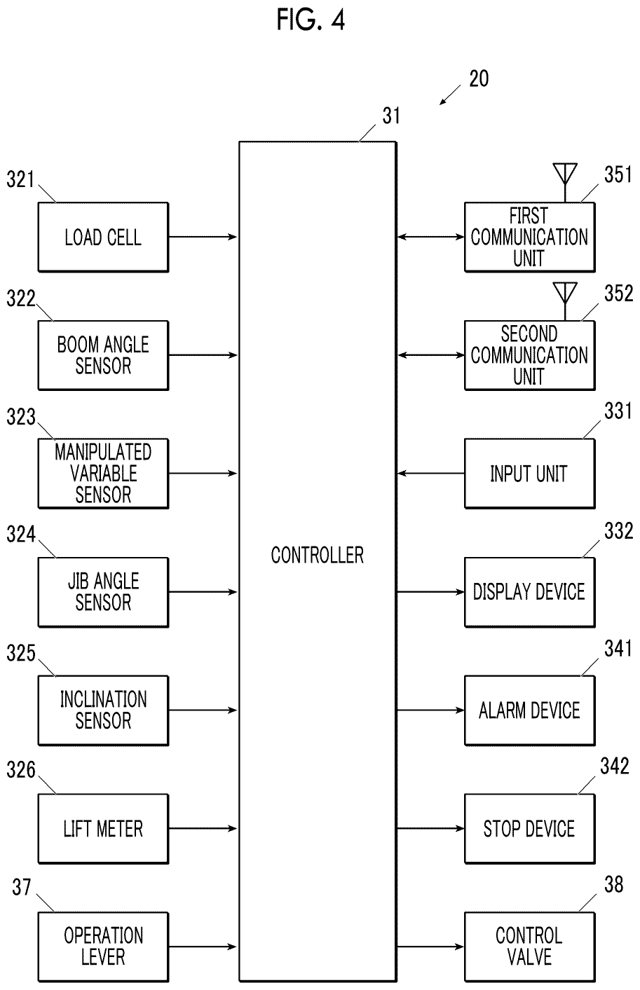

As will be described later, the crane 20 includes various sensors that detect a state of each part of the crane 20 itself, and a controller 31 (refer to FIG. 4). The controller 31 transmits information detected by various sensors to the base stations 120 and 150 or receives predetermined information by using a first communication unit 351 and a second communication unit 352 (refer to FIG. 4).

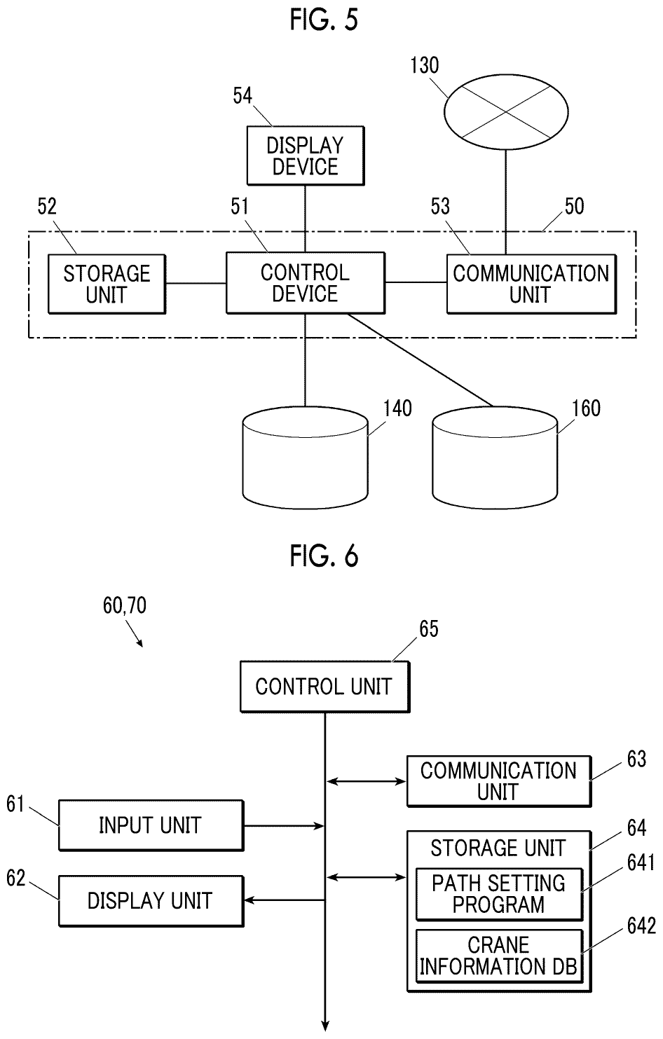

An inspection information database 140 and a customer information database 160 are connected to the management server 50. A control device 51 (refer to FIG. 5) included in the management server 50 stores diagnostic information data (to be described later) received from the moving body 40 and the crane 20 via the base stations 120 and 150, and state information data generated from the diagnostic information data, in the inspection information database 140.

The control device 51 included in the management server 50 transmits the state information data stored in the inspection information database 140 to the predetermined information terminals 60 and 70 via the network 130. The control device 51 included in the management server 50 determines a transmission destination of the information, based on contents of the customer information database 160. For example, the information is transmitted to the information terminal 60 used by a jobsite supervisor who is a user of the crane 20, a serviceman of a crane maker, or the like, or the information terminal 70 used by a manager who is a user related to a business using the crane 20 at a location away from a jobsite, and is displayed on display screens of the information terminals 60 and 70.

Although FIG. 1 illustrates only one of each of the crane 20 and the information terminals 60 and 70, the management server 50 is actually configured to transmit and receive information between a large number of the cranes 20 and a large number of the information terminals 60 and 70.

### Moving Body

Here, the moving body 40 will be described.

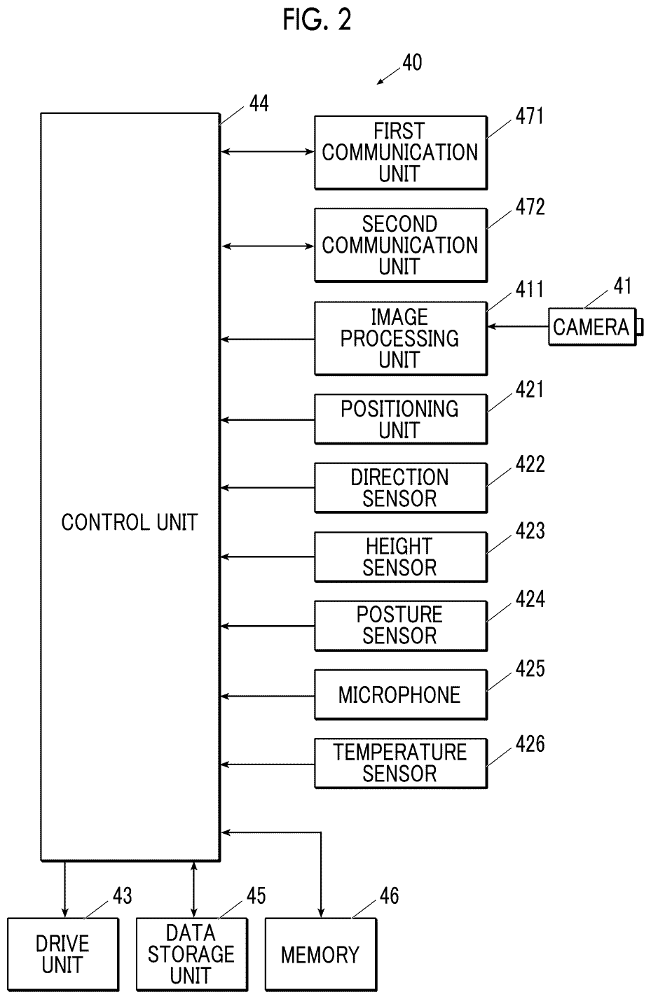

FIG. 2 is a block diagram illustrating a control system of the moving body 40.

The moving body 40 is an unmanned aerial vehicle (unmanned aircraft) which is a so-called drone. The moving body 40 has a plurality of rotors, flies by controlling an output of a motor serving as a drive source of each rotor, and can freely perform raising and lowering operations, forward, rearward, rightward, and leftward movements, and normal and reverse turning.

The moving body 40 moves around the crane 20 serving as the inspection target, images each part of the crane 20, and transmits acquired captured image data to the predetermined information terminals 60 and 70 and the management server 50.

As illustrated in FIG. 2, the moving body 40 includes a camera 41 (detection unit) serving as an imaging unit, a positioning unit 421, a direction sensor 422, a height sensor 423, a posture sensor 424, a microphone (sound detection sensor) 425, a temperature sensor 426, a drive unit 43, a control unit 44, a data storage unit 45, a memory 46, a first communication unit 471, and a second communication unit 472.

All sensors such as the positioning unit 421, the direction sensor 422, the height sensor 423, the posture sensor 424, the microphone 425, and the temperature sensor 426 which are described above may not be mounted on the moving body 40. The moving body 40 may include at least the camera 41, the positioning unit 421, and the direction sensor 422.

The camera 41 (detection unit) is supported to be directed from the machine body of the moving body 40 in a predetermined direction, and images a scene ahead of the line of sight in accordance with a direction of the machine body. The camera 41 can continuously acquire captured images at a constant frame rate. In this manner, it is possible to image a plurality of locations including an inspection location. An image signal obtained by imaging is output to an image processing unit 411 connected to the camera 41. Captured image data having a predetermined format is generated by the image processing unit 411, and is recorded in the memory 46.

The camera 41 is not limited to those which acquire an image of visible light, and an infrared camera for imaging infrared rays may be used. When an infrared camera is used, distance image data can be obtained by using a phase difference method.

In addition, the camera 41 is not limited to a monocular camera, and a stereo camera may be used. In this case, the distance image data can also be obtained.

The positioning unit 421 is a global navigation satellite system (GNSS) receiver, and measures a current position of the moving body 40. A real time kinematic (RTK) which is much more accurate than a global positioning system (GPS) is applied to the positioning unit 421 of the present embodiment.

The direction sensor 422 is a three-axis gyro direction sensor, and detects an advancing direction of the moving body 40 and an inclination angle of the machine body.

For example, the height sensor 423 is an optical type, and projects light downward to detect a height of the machine body from a phase difference generated by reflected light thereof.

The posture sensor 424 includes a three-dimensional acceleration sensor, and detects acceleration in each direction of an X-axis, a Y-axis, and a Z-axis which are defined in the moving body 40. A posture of the machine body can be detected from gravitational acceleration detected for each of these axes.

The microphone 425 has directivity, and detects sound of an object located ahead in a direction the same as that of the line of sight of the camera 41.

The temperature sensor 426 is a so-called radiation thermometer having a non-contact type, and detects a temperature of the object located ahead in the direction the same as that of the line of sight of the camera 41.

Each of these sensors may be used in any desired way as long as desired information can be detected, and a sensor type or a detection principle is not limited to the above-described example.

The first communication unit 471 performs data communication with the base station 120 via the satellite 110.

The second communication unit 472 directly performs data communication with the base station 150.

The drive unit 43 is configured to output a thrust force for a moving operation of the moving body 40, and has a plurality of rotors and a plurality of motors serving as rotational drive sources provided in each of the rotors. The drive unit 43 is controlled by the control unit 44 so that the machine body moves in a target movement direction.

The data storage unit 45 is a non-volatile storage device that stores various information related to a control program and control of the moving body 40.

The memory 46 stores captured image data captured by the camera 41 and detection data detected by the microphone 425 and the temperature sensor 426.

The memory 46 may include a non-volatile storage device. In addition, the memory 46 may include a removable recording medium. In that case, the captured image data and the detection data can be exchanged with the external information terminals 60 and 70 and the management server 50 by using the removed recording medium without using the network 130.

The control unit 44 comprehensively controls each part of the moving body 40, based on a control program stored in the data storage unit 45 and a control command transmitted from the information terminals 60 and 70.

For example, the control unit 44 acquires information on a position and a posture of the moving body 40 during imaging and detecting from the direction sensor 422 and the posture sensor 424, and records the information in the memory 46 in association with the captured image data and the detection data (hereinafter, the captured image data and the detection data which are associated with the information on the position and the posture of the moving body 40 during imaging and detecting will be referred to as “diagnostic information data”). In addition, the control unit 44 transmits the diagnostic information data to the information terminals 60 and 70 and the management server 50 via the first communication unit 471 and the second communication unit 472.

### Crane

Subsequently, the crane 20 will be described.

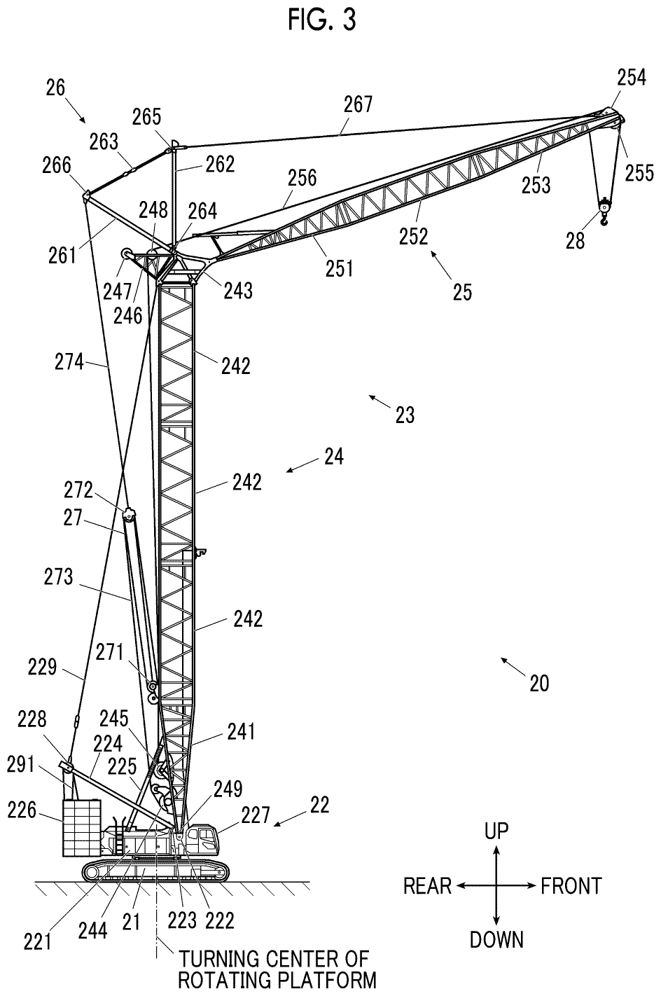

FIG. 3 is a side view of the crane 20.

In the present embodiment, a so-called mobile crawler crane will be described as an example of the crane 20. With regard to the description of the crane 20 below, a direction in which a rope is suspended from a boom when viewed from a turning center of the crane 20 is defined as “front”, a direction opposite to the front (in other words, a side where a counterweight is disposed from the turning center) is defined as “rear”, a left hand side in a state of facing the front is defined as “left”, and a right hand side in a state of facing the front is defined as “right”. The front and rear sides of specific locations of the crane 20 can be relatively expressed as appropriate. For example, when a first specific location on the “front” side and a second specific location on the “front” side in the front-rear direction of the crane 20 are compared, and when the second specific location is located between the first specific location and the turning center of the crane 20, the second specific location is relatively expressed to be located on the “rear” side when viewed from the first specific location. In addition, when the first specific location on the “rear” side and the second specific location on the “rear” side in the front-rear direction of the crane 20 are compared, and when the second specific location is located between the first specific location and the turning center of the crane 20, the second specific location is relatively expressed to be located on the “front” side when viewed from the first specific location.

As illustrated in FIG. 3, the crane 20 includes a crawler-type lower traveling body 21 capable of self-propelling, a rotating platform 22 mounted on the lower traveling body 21 to be capable of turning, and a front attachment 23 attached to a front side of the rotating platform 22 to be capable of derricking.

The rotating platform 22 forms a main body of the crane 20, and has a turning frame 221 extending in a front-rear direction. A boom attachment portion 222 is provided on a front side of the turning frame 221, and a base end 249 of a tower boom 24 (to be described later) is attached to the boom attachment portion 222 to be capable of derricking.

In addition, in the turning frame 221, a mast attachment portion 223 is provided in the vicinity of a rear side of the boom attachment portion 222. A base end of a mast 224 (to be described later) is attached to the mast attachment portion 223 to be pivotable. Furthermore, in the turning frame 221, a base end of a backstop 225 (to be described later) is attached to a rear side of the mast attachment portion 223 to be pivotable.

A counterweight 226 for balancing a weight between the front attachment 23 and a suspended load is disposed on the rear side of the turning frame 221. In addition, a boom derricking winch (not illustrated) is disposed on the rear side of the turning frame 221. Meanwhile, a cab 227 in which a driver's seat and various operation devices (all are not illustrated) are disposed is provided on a front right side of the turning frame 221.

The front attachment 23 is provided in the rotating platform 22, and transports luggage such as materials between the ground and a high place. The front attachment 23 includes the tower boom 24, a tower jib 25, and a tower strut 26.

The tower boom 24 is attached to the rotating platform 22 to be capable of derricking. The tower boom 24 includes a lower boom 241 whose base end (foot portion) 249 is attached to the boom attachment portion 222 of the turning frame 221 to be capable of derricking, a plurality of (for example, three stages of) intermediate booms 242 whose base ends are attached to a tip of the lower boom 241, and an upper boom 243 attached to a tip of the intermediate boom 242 located on a most tip side. A jib derricking winch 244 and a main winding winch 245 (to be described later) are attached to the lower boom 241.

As illustrated, pillar members of the intermediate booms 242 adjacent to each other in a length direction are respectively connected by using a connecting pin. In addition, the intermediate boom 242 located on a lowermost side and the lower boom 241, and the intermediate boom 242 located on an uppermost side and the upper boom 243 are respectively connected by using connecting pins.

The upper boom 243 has a shape whose upper portion protrudes forward when the tower boom 24 is in a standing posture (posture illustrated in FIG. 3). A lower side portion of the upper boom 243 is attached to a tip (upper end) of the intermediate boom 242 located on the uppermost side. The tower jib 25 (to be described later) is attached to a front end side of the upper boom 243 to be capable of derricking, and the tower strut 26 (to be described later) is attached to an upper end side of the upper boom 243 to be capable of oscillating. In addition, a triangular sheave bracket 246 projects rearward in the upper boom 243. A tower guide sheave 247 and a guide sheave 248 are attached to the sheave bracket 246 to be rotatable.

The tower jib 25 is attached to the tip of the upper boom 243 of the tower boom 24 to be capable of derricking. The tower jib 25 is configured to include a lower jib 251 whose base end is attached to the upper boom 243 to be capable of derricking, an intermediate jib 252 attached to a tip of the lower jib 251, and an upper jib 253 provided in a tip of the intermediate jib 252. A guide sheave 254 and a point sheave 255 are attached to a tip side of the upper jib 253 to be rotatable. A main winding rope 256 (to be described later) is wound around the guide sheave 254 and the point sheave 255.

The tower strut 26 is attached to an upper end side of the upper boom 243 of the tower boom 24 to be capable of oscillating. The tower strut 26 connects a first strut 261, a second strut 262, and a third strut 263 by using a first connecting portion 264, a second connecting portion 265, and a third connecting portion 266. In this manner, the tower strut 26 is configured as a triangular structure.

Here, the first connecting portion 264 of the tower strut 26 is attached to the upper end side of the upper boom 243. In this manner, the tower strut 26 is attached to an upper end of the tower boom 24 to be capable of oscillating while the first connecting portion 264 serves as a fulcrum. In addition, one end of a pendant rope 267 is connected to the second connecting portion 265, and the other end of the pendant rope 267 is connected to the tip side of the upper jib 253 of the tower jib 25. Furthermore, a boom-side pendant rope 274 (to be described later) is connected to the third connecting portion 266.

The jib derricking winch 244 is attached to the lower boom 241 of the tower boom 24. The jib derricking winch 244 causes the tower jib 25 to perform derricking via the tower strut 26. The jib derricking winch 244 and the third connecting portion 266 of the tower strut 26 are connected to each other by a jib derricking rope 27.

The jib derricking rope 27 is provided between the jib derricking winch 244 and the tower strut 26. The jib derricking rope 27 is configured to include a lower spreader 271 having a plurality of sheaves attached to the intermediate boom 242 of the tower boom 24, an upper spreader 272 having a plurality of sheaves provided to face the lower spreader 271, a winding rope 273 wound around the jib derricking winch 244 in a state of being sequentially wound around the sheave of the lower spreader 271 and the sheave of the upper spreader 272, and a boom-side pendant rope 274 in which one end is connected to the upper spreader 272 and the other end is connected to the third connecting portion 266 of the tower strut 26.

Therefore, the winding rope 273 is wound and unwound by the jib derricking winch 244. In this manner, the upper spreader 272 moves close to and away from the lower spreader 271, and the tower strut 26 oscillates while the first connecting portion 264 serves as a fulcrum. The oscillation of the tower strut 26 is transmitted to the tower jib 25 via the pendant rope 267. In this manner, the tower jib 25 is configured to perform derricking on the tip side of the tower boom 24.

The main winding winch 245 is located in the vicinity of the upper side of the jib derricking winch 244, and is attached to the lower boom 241 of the tower boom 24. One end side of the main winding rope 256 is wound around the main winding winch 245. The other end side of the main winding rope 256 is attached to a suspended load hook 28 via the guide sheave 248 of the sheave bracket 246, the guide sheave 254 of the tower jib 25, and the point sheave 255. Therefore, the main winding rope 256 is wound and unwound by the main winding winch 245 so that the suspended load hook 28 can be raised and lowered.

The backstop 225 is provided between the turning frame 221 and the lower boom 241 of the tower boom 24. The backstop 225 supports the standing tower boom 24 from behind.

A base end of the mast 224 is attached to the mast attachment portion 223 of the turning frame 221 to be pivotable. The tip of the mast 224 is a free end that is pivotable in the up-down direction or the front-rear direction.

A boom spreader 228 is provided at the tip of the mast 224, and the boom spreader 228 and the upper boom 243 of the tower boom 24 are connected to each other via a pendant rope 229 having a certain length. In addition, a boom derricking rope 291 sequentially wound over the boom spreader 228 and a spreader (not illustrated) on the turning frame 221 side is wound around a tower boom derricking winch (not illustrated) provided in the turning frame 221.

Therefore, the boom derricking rope 291 is wound or unwound by the tower boom derricking winch. In this manner, the tower boom 24 can perform derricking (raising or lowering) via the pendant rope 229.

FIG. 4 is a block diagram illustrating a control system of the crane 20.

As illustrated in the drawing, the crane 20 includes the controller 31 that comprehensively controls each part of the crane 20. More specifically, the controller 31 performs control of various operations such as traveling, turning, and load suspending of the crane 20, and an abnormality detection process. The controller 31 is configured to include an arithmetic processing device having a CPU, a ROM and a RAM which are storage devices, and other peripheral circuits.

In addition, as sensors for acquiring information related to a state of each part of the crane 20, the crane 20 includes a load cell 321, a boom angle sensor 322, a manipulated variable sensor 323, a jib angle sensor 324, an inclination sensor 325, and a lift meter 326.

The load cell 321 is attached to the boom spreader 228, detects tension acting on the boom derricking rope 291 that causes the tower boom 24 to perform derricking, and outputs a control signal corresponding to the detected tension to the controller 31.

The boom angle sensor 322 is attached to a base end side of the tower boom 24, detects a derricking angle (hereinafter, also referred to as a boom angle) of the tower boom 24, and outputs a control signal corresponding to the detected boom angle to the controller 31.

For example, the boom angle sensor 322 detects a ground angle, which is an angle with respect to a horizontal plane, as a boom angle.

The jib angle sensor 324 is attached to the base end side of the tower jib 25, detects a derricking angle (hereinafter, also referred to as a jib angle) of the tower jib 25, and outputs a control signal corresponding to the detected jib angle to the controller 31. For example, the jib angle sensor 324 detects a ground angle, which is an angle with respect to a horizontal plane, as a jib angle.

For example, the manipulated variable sensor 323 detects an operation amount of a hydraulic pilot-type operation lever, and outputs a control signal corresponding to the detected operation amount to the controller 31.

The inclination sensor 325 detects inclination of the crane 20, that is, inclination of the ground on which the crane 20 is located, and outputs the inclination to the controller 31.

The lift meter 326 detects a height position of the suspended load hook 28, and outputs the height position to the controller 31.

In addition, the crane 20 includes an input unit 331, a display device 332, an alarm device 341, a stop device 342, a first communication unit 351, a second communication unit 352, an operation lever 37, and a control valve 38.

For example, the input unit 331 is a touch panel, and outputs a control signal corresponding to an operation from a worker to the controller 31. The worker can operate the input unit 331 to set the number of application times of the main winding rope 256, the tower boom length, and the mass of the suspended load hook 28.

For example, the display device 332 includes a touch panel-type display that is also used as the input unit 331, and displays information on a suspended load or information on a work posture on a display screen, based on a control signal output from the controller 31.

The alarm device 341 issues an alarm, based on a control signal output from the controller 31.

The stop device 342 stops driving of a hydraulic motor (not illustrated) connected to each of the main winding winch 245 and the jib derricking winch 244, based on a control signal output from the controller 31. For example, the stop device 342 is an electromagnetic switching valve that can cut off the supply of pressure oil from a hydraulic pump to a hydraulic motor.

The first communication unit 351 performs data communication with the base station 120 via the satellite 110.

The second communication unit 352 directly performs data communication with the base station 150.

The control valve 38 is configured to include a plurality of valves that can be switched in accordance with a control signal from the controller 31.

For example, the control valve 38 includes a valve for hydraulic pressure supply, interruption, and rotation direction switching from the hydraulic pump included in the crane 20 to the hydraulic motor that rotationally drives drive wheels of the lower traveling body 21, a valve for hydraulic pressure supply, interruption, and rotation direction switching from the hydraulic pump to the hydraulic motor that performs a turning operation of the rotating platform 22, a valve for hydraulic pressure supply, interruption, and rotation direction switching from the hydraulic pump to the hydraulic motor that rotationally drives the tower boom derricking winch, a valve for hydraulic pressure supply, interruption, and rotation direction switching from the hydraulic pump to the hydraulic motor that rotationally drives the jib derricking winch 244, and a valve for hydraulic pressure supply, interruption, and rotation direction switching from the hydraulic pump to the hydraulic motor that rotationally drives the main winding winch 245.

The operation lever 37 is configured to include a plurality of levers for inputting control signals for individually performing switching to various valves of the control valve 38 through the controller 31.

For example, a traveling lever which is one of the operation levers 37 inputs a switching signal to a valve that performs hydraulic pressure supply, interruption, and rotation direction switching for the hydraulic motor that rotationally drives the drive wheels of the above-described lower traveling body 21.

In addition, a turning lever which is one of the operation levers 37 inputs a switching signal to a valve that performs hydraulic pressure supply, interruption, and rotation direction switching from the above-described hydraulic pump to the hydraulic motor that performs a turning operation of the rotating platform 22.

In addition, a boom derricking lever which is one of the operation levers 37 inputs a switching signal to a valve that performs hydraulic pressure supply, interruption, and rotation direction switching from the above-described hydraulic pump to the hydraulic motor that rotationally drives the tower boom derricking winch.

In addition, a jib derricking lever which is one of the operation levers 37 inputs a switching signal to a valve that performs hydraulic pressure supply, interruption, and rotation direction switching from the above-described hydraulic pump to the hydraulic motor that rotationally drives the jib derricking winch 244.

In addition, a winding lever which is one of the operation levers 37 inputs a switching signal to a valve that performs hydraulic pressure supply, interruption, and rotation direction switching from the above-described hydraulic pump to the hydraulic motor that rotationally drives the main winding winch 245.

The controller 31 inputs control signals corresponding to hydraulic pressure supply, interruption, and rotation direction switching to each valve configuring the corresponding control valve 38 in accordance with an operation of various levers configuring the operation lever 37, and performs control on each hydraulic motor.

In this manner, the worker operates the operation lever 37. In this manner, the worker can perform a traveling operation of the crane 20, a turning operation of the rotating platform 22, a derricking operation of the tower boom 24, a derricking operation of the tower jib 25, and raising and lowering operations of the suspended load hook 28.

### Management Server

FIG. 5 is a block diagram illustrating a configuration of the management server 50.

As illustrated in the drawing, the management server 50 has a control device 51, a storage unit 52, and a communication unit 53.

The control device 51 includes an arithmetic processing device having a CPU and peripheral circuits. The control device 51 controls each unit of the management server 50 by reading and executing a control program stored in advance in the storage unit 52.

For example, the storage unit 52 is a non-volatile storage device.

The communication unit 53 performs data communication (transmission and reception) via the network 130 in accordance with a predetermined procedure.

A display device 54 is connected to the control device 51, and the control device 51 causes a display screen of the display device 54 to display information stored in the storage unit 52, the inspection information database 140, and the customer information database 160.

The inspection information database 140 and the customer information database 160 are connected to the control device 51.

The inspection information database 140 stores data in association with date and time information, a work machine ID of the crane 20, and a diagnosis result which are received from the moving body 40 via the base stations 120 and 150 (including a case of receiving information via the crane 20) by the control device 51.

The customer information database 160 stores data in association with the work machine ID of the crane 20, customer information related to a customer who owns the crane 20, and a delivery destination address of the customer. The delivery destination address of the customer corresponding to one work machine ID can be set in any desired way.

In this manner, when the information in the inspection information database 140 of the crane is updated for the specific crane 20, the control device 51 specifies the customer and the delivery destination thereof, and transmits the updated information on the crane 20, or notifies of the updated information. In addition, when there is an access from the customer side, the control device 51 may allow transmitting or reading various information recorded in the inspection information database 140 of the crane related to the crane 20 of the customer. In this case, a password may be set for each customer in the customer information database 160, and the password may be requested when there is an access from the customer side. It is preferable that the password is registered in the customer information database 160.

The control device 51 performs a diagnostic process of determining whether or not there is an abnormality in inspection locations of the crane 20 with respect to the following inspection items, based on the diagnostic information data including the captured image data and the detection data which are acquired from the moving body 40.

The inspection items are as follows, for example.
(1) Cracks, deformation, damage, and corrosion in a tower boom and a tower jib
(2) Abrasion and damage in a foot pin, a joint pin, and a bush
(3) Abrasion, damage, random winding, terminal state, and corrosion of a wire rope
(4) Damage and corrosion in a pendant rope
(5) Cracks, deformation, damage, and corrosion in each spreader, a hanger, and a tower strut
(6) Cracks, deformation, abrasion, and corrosion of a suspended load hook
(7) Operation state, deformation, and damage in a wire detachment stopper of the suspended load hook
(8) Loosening of a nut of the suspended load hook, and damage and corrosion in a screw portion
(9) Abrasion, deformation, damage, and corrosion in each sheave
(10) Operation state of an excessive winding prevention device in the suspended load hook, the tower boom, and the tower jib
(11) Operation state of a load cell and a boom angle sensor
(12) Deformation, damage, and corrosion in a backstop
(13) Whether or not an attachment is attached to a regular position, and an attachment state (bolt tightening omission or bolt missing)

### Information Terminal

FIG. 6 is a block diagram illustrating a schematic control system of the information terminals 60 and 70. Since the information terminals 60 and 70 of the present embodiment have substantially the same configuration, the information terminal 60 will be described below, and description of the information terminal 70 will be omitted.

For example, the information terminal 60 is a terminal device such as a personal computer, a smartphone, and a tablet terminal, and includes an input unit 61, a display unit 62, a communication unit 63, a storage unit 64, and a control unit 65 as illustrated in FIG. 6.

For example, the input unit 61 includes a touch panel, and outputs an input signal corresponding to operation contents of a user operating the touch panel to the control unit 65.

For example, the display unit 62 includes a touch panel-type display 620 (refer to FIG. 11), and displays various information on the display 620, based on a display signal input from the control unit 65.

The communication unit 63 can perform data communication (transmission and reception) with the crane 20, the moving body 40, and the management server 50 via the network 130. The communication unit 63 also functions as an information transmission unit that transmits flight information for causing the moving body 40 to fly along a flight path set by the control unit 65 (flight path setting unit) to the moving body 40. The communication unit 63 may be configured to be capable of direct communication with the crane 20, the moving body 40, and the management server 50.

The storage unit 64 is a memory including a random access memory (RAM) or a read only memory (ROM), stores various programs and data, and also functions as a work region of the control unit 65.

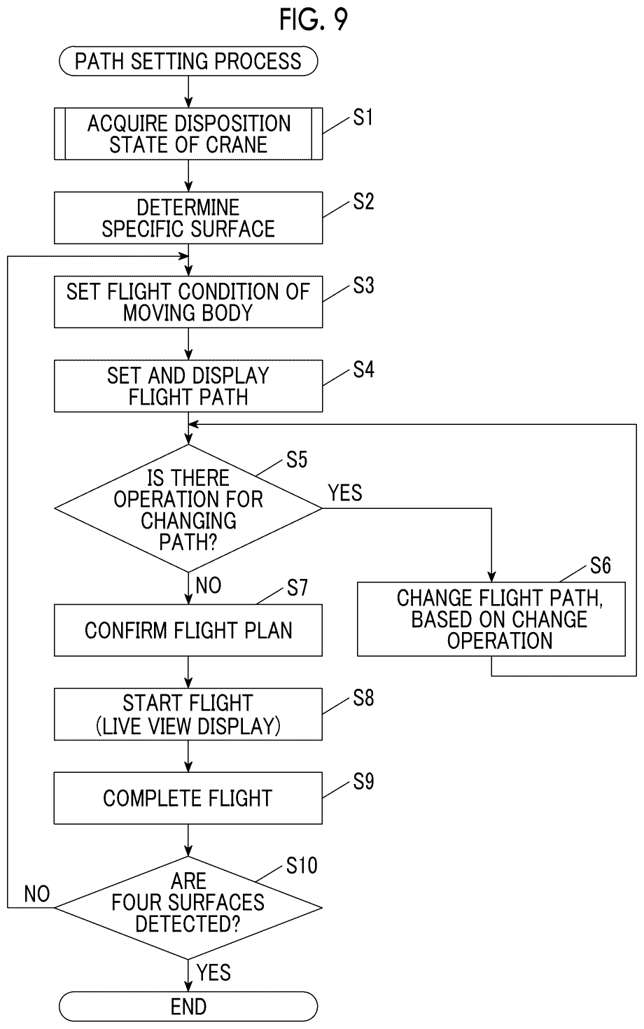

In the present embodiment, the storage unit 64 pre-stores a path setting program 641 for performing a path setting process (refer to FIG. 9, to be described later).

In addition, the storage unit 64 has a crane information database (DB) 642 which stores various information related to the crane.

In the crane information DB 642, a plurality of model information (model name) and information related to a structure of each model (including a shape and a main dimension of each part) are stored in association with each other. For example, the information related to the structure of the crane includes a type such as a derricking method (A-frame, live mast, or both of these), a tower jib derricking method (swing lever or rougher), and a front specification (crane only, tower only, or both of these).

The crane information DB 642 may be stored in another device (for example, the management server 50) with which the information terminal 60 can communicate (read information).

The control unit 65 comprehensively controls the information terminal 60, based on a user operation. Specifically, the control unit 65 reads various programs from the storage unit 64 in response to an operation signal input from the input unit 61, performs a predetermined process in accordance with the program, temporarily stores a process result thereof in the storage unit 64, and appropriately outputs the process result to the display unit 62.

### Flight Method for Moving Body

Hereinafter, a flight method for the moving body 40 which enables inspection work for the crane 20 to be carried out by the moving body 40 even in a narrow work site will be described.

### Determination of Flight-Available Range of Moving Body

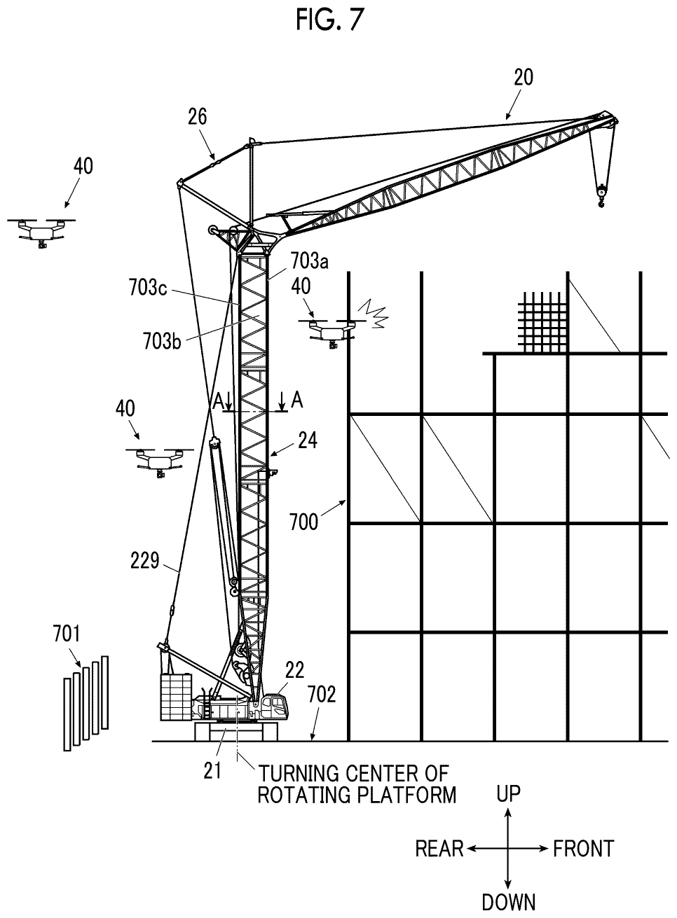

FIG. 7 is a view illustrating an example of the crane 20 disposed in a narrow work site.

The crane 20 illustrated in FIG. 7 is disposed in a passage 702 between a construction body 700 and a partition wall 701, and the lower traveling body 21 can move along a direction in which the passage 702 extends (along a direction perpendicular to the paper surface in FIG. 7). However, the lower traveling body 21 is restricted from moving in the left-right direction by the construction body 700 and the partition wall 701. Therefore, the crane 20 illustrated in FIG. 7 carries out work on the construction body 700 in a state where the rotating platform 22 of the crane 20 illustrated in FIG. 3 is turned 90° in a counterclockwise direction.

In FIG. 7, a flight-available range of the moving body 40 during the inspection work for the crane 20 is restricted by the construction body 700 and the partition wall 701. Therefore, the flight-available range is limited to a space along the passage 702 and an upper space of the construction body 700, and an orbital flight for freely orbiting around the crane 20 is not available.

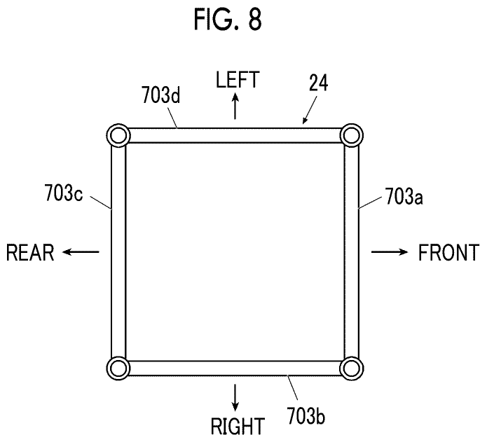

Here, in the present embodiment, when the crane 20 illustrated in FIG. 3 includes four surfaces having a quadrangular shape (refer to FIG. 8) in a cross section (cross section taken along line A-A in FIG. 7) taken by a virtual plane perpendicular to a longitudinal direction of a tower boom (hereinafter, abbreviated as a boom) 24, for convenience of description, a front side surface will be defined as a first surface 703a, and other surfaces will be sequentially defined as second to fourth surfaces (703b to 703d) in a clockwise direction, based on the first surface 703a. That is, the crane 20 in FIG. 3 will be described while the front side surface is set as the first surface 703a, a rear side surface is set as the third surface 703c, a left side surface facing forward is set as the fourth surface 703d, and a right side surface facing forward is set as the second surface 703b. Two surfaces parallel to the front-rear direction of the rotating platform 22 of the crane 20 and located on both outer sides in the left-right direction of the rotating platform 22 will be defined as the two left-right surfaces (703b and 703d), and two surfaces perpendicular to the front-rear direction of the rotating platform 22 and located on both outer sides in the front-rear direction of the rotating platform 22 will be defined as the two front-rear surfaces (703a and 703c). In this manner, description will be continued as appropriate.

In the crane 20 illustrated in FIG. 7, the second surface 703b and the fourth surface 703d of the boom 24 are surfaces facing the front-rear direction of the passage 702, and the moving body 40 is caused to perform a single surface flight at a predetermined interval (interval having no possibility that the moving body 40 comes into contact with the crane 20) from the second surface 703b and the fourth surface 703d. In this manner, the inspection work can be carried out to inspect a state on the second surface 703b side and the fourth surface 703d side of the crane 20. A single surface flight process of the moving body 40 on the second surface 703b side and the fourth surface 703d side of the crane 20 will be defined as a first flight process. In the first flight process, the second surface 703b and the fourth surface 703d of the crane 20, which are surfaces on which the moving body 40 can perform the single surface flight with the interval having no possibility that the moving body comes into contact with the crane 20, will be defined as surfaces of a normal portion other than a specific portion. In addition, in the first flight process, the surfaces (first surface 703a and third surface 703c) on which the moving body 40 cannot fly while being detected by the camera 41 (detection unit) will be defined as surfaces of the specific portion.

On the other hand, in the crane 20 illustrated in FIG. 7, the first surface 703a of the boom 24 faces the construction body 700, and an interval between the first surface 703a of the boom 24 and the construction body 700 is narrow (narrower than a safe distance at which the moving body 40 does not collide with the crane 20 and the construction body 700 during a flight). In addition, in the crane 20 illustrated in FIG. 7, the third surface 703c of the boom 24 faces the partition wall 701, and an interval between the third surface 703c side of the boom 24 and the partition wall 701 is narrow (narrower than a safe distance at which the moving body 40 does not collide with the crane 20 and the partition wall 701 during the flight). Furthermore, in the crane 20 illustrated in FIG. 7, the moving body 40 protrudes to the outside of a site (entry prohibited area) in order to avoid contact with the tower strut 26 on the third surface 703c side. Therefore, in the crane 20 illustrated in FIG. 7, the first surface 703a and the third surface 703c are specific surfaces located in a space where the moving body 40 cannot fly. In addition, the specific surface is a surface located in a space where the moving body cannot fly due to a flight prohibited area (important classified facility, aerial area, safety passage (area secured to allow a passage of persons), public road, or the like).

Thereafter, in the crane 20 illustrated in FIG. 7, the rotating platform 22 is rotated 90° in the clockwise direction, and the first surface 703a and the third surface 703c are caused to face an extending direction of the passage 702. In this manner, a space in which the moving body 40 can fly can be secured around the first surface 703a and around the third surface 703c. Therefore, the moving body 40 can perform the single surface flight at a predetermined interval from the first surface 703a and the third surface 703c, and the inspection work can be carried out on the first surface 703a side and the third surface 703c side of the crane 20. In this way, a process of flying while the moving body 40 causes the camera 41 (detection unit) to detect a surface of the specific portion of the crane 20 in a state where at least one of a position of the crane 20, a turning angle of the rotating platform 22, and a boom angle is different compared to a state of the crane 20 in the first flight process will be defined as a second flight process. When it is assumed that the moving body 40 is located on the first surface 703a side and the third surface 703c side which are defined as the specific surfaces in the first flight process, a portion detectable by the camera 41 (detection unit) of the moving body 40 will be defined as a specific portion.

The inspection work on the first surface 703a side of the crane 20, the inspection work on the third surface 703c side, the inspection work on the second surface 703b side, and the inspection work on the fourth surface 703d side may be simultaneously carried out by a plurality of the moving bodies 40 in addition to a case where the inspection work is sequentially carried out by one moving body 40. In addition, in order to secure a space in which the moving body 40 can fly around the specific surface, it is conceivable to turn the above-described rotating platform 22. In addition, it is conceivable to perform a derricking operation of the boom 24, to move the crane, and to combine all of these.

The specific surface in the above description may be determined by a worker visually checking an actual work site. In addition, as will be described later, the specific surface may be automatically determined, based on a construction plan (BIM) at an actual work site, map information on a jobsite, GPS information on an installation position of the crane, and the like in the flight path setting process of the moving body 40. The specific surface can be determined, based on a building shape varying depending on a progress status of a construction plan and a coordinate position of the crane 20 varying depending on the construction plan. Therefore, the specific surface is accurately determined depending on the progress status of the construction plan.

### Flight Path Determination of Moving Body

Subsequently, a path setting process of setting a flight path (flight route) of the moving body 40 during the inspection of the crane 20 will be described.

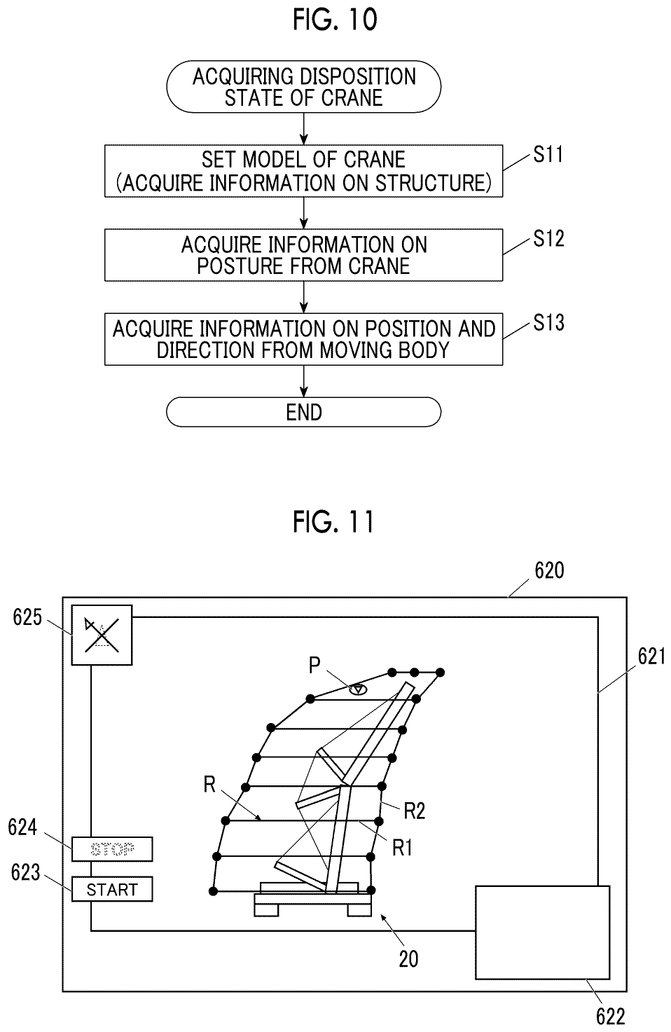

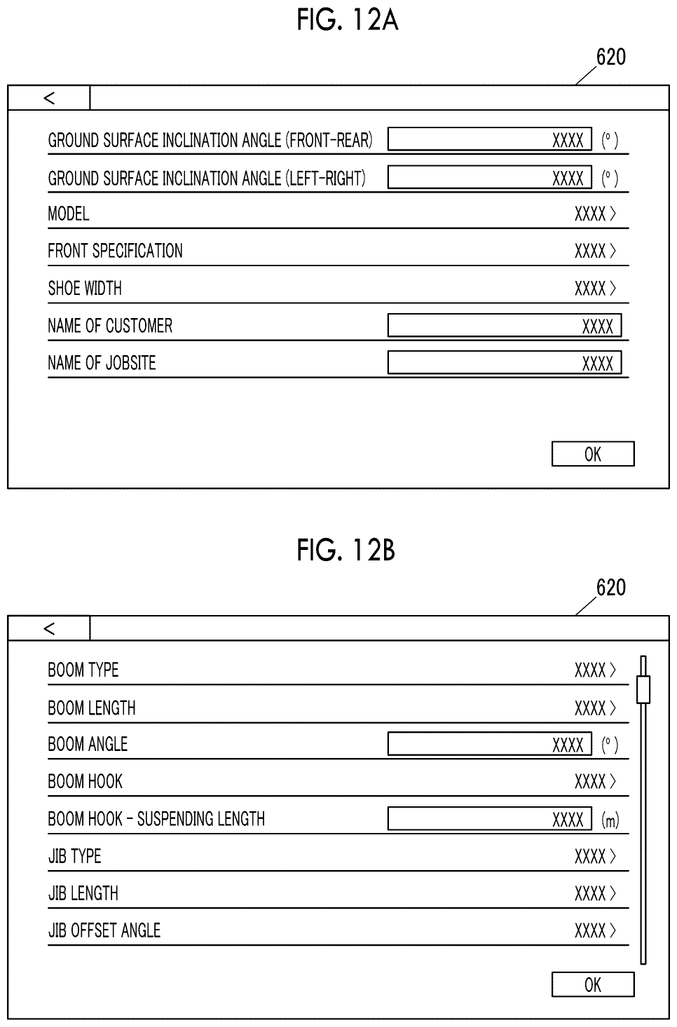

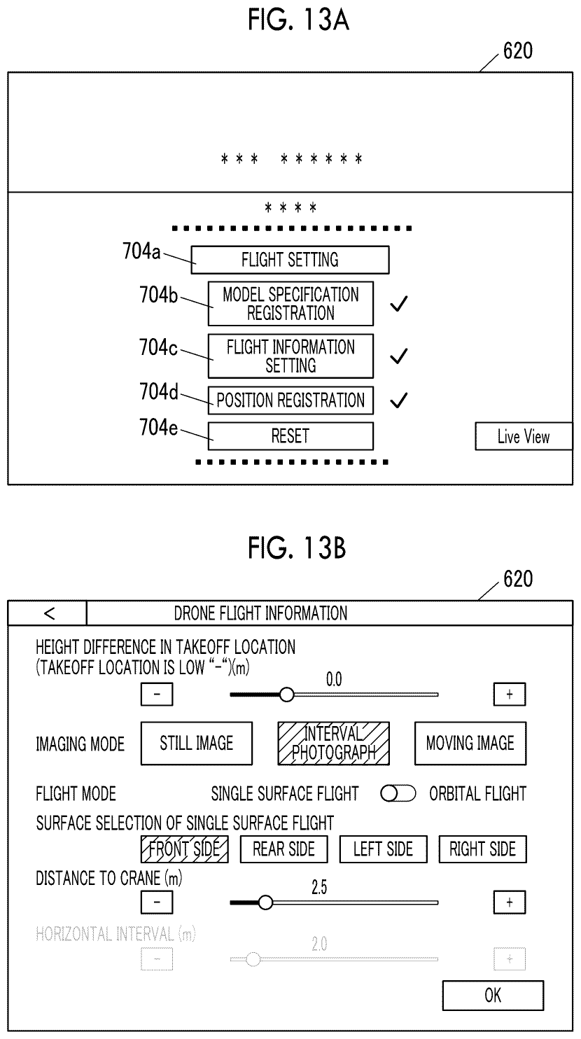

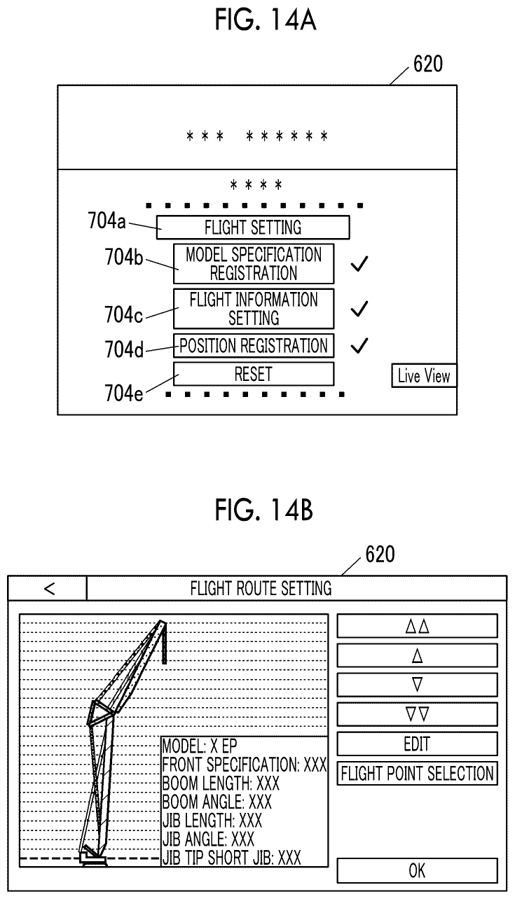

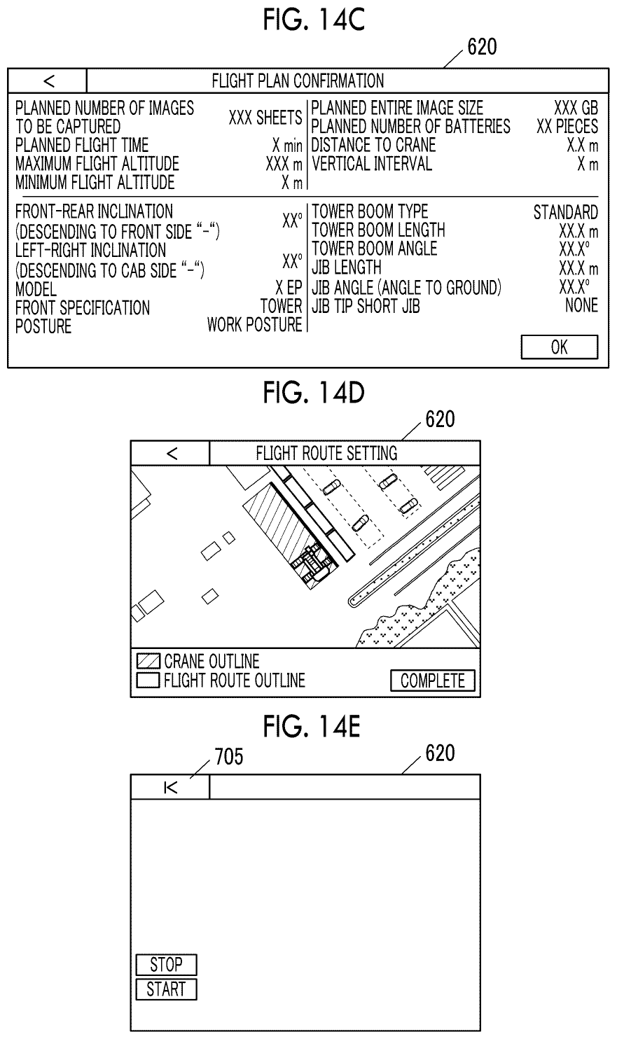

FIGS. 9 and 10 are flowcharts illustrating a flow of the path setting process. FIG. 11 is a view illustrating a display example of a flight path of the moving body 40 on the second surface 703b side of the crane 20. FIGS. 12A and 12B are examples of an information setting screen in the path setting process. FIGS. 13A and 13B are examples of a flight information setting screen. In addition, FIGS. 14A to 14E are examples of a flight setting screen.

Here, a case where a user operates the information terminal 60 as a flight setting device to perform the path setting process and sets the flight path of the moving body 40 will be described.

The path setting process is performed in such a manner that the control unit 65 of the information terminal 60 reads and deploys a path setting program 641 from the storage unit 64 as the flight path setting unit.

Here, it is assumed that the crane 20 is stationary in an assembled state. In addition, in the following description, in the path setting process, the moving body 40 flies along the flight path after the flight path is set. However, the flight of the moving body 40 may not be included in the path setting process.

As illustrated in FIG. 9, when the path setting process is performed, first, the control unit 65 acquires data of a disposition state of the crane 20 (hereinafter, referred to as “disposition state data”) (Step S1).

Here, the “disposition state” of the crane 20 refers to a state related to at least one of a structure (including a size and a shape), a posture, a position, and a direction of the crane 20.

Specifically, the control unit 65 displays a top screen of the flight setting illustrated in FIG. 13A, and when the user presses a model specification registration button 704b, the control unit 65 sets a model of the crane 20 as illustrated in FIG. 10 (Step S11). When the user selects the model of the crane 20 via the input unit 61, the control unit 65 reads information related to the structure (including the size and the shape) of the model from the crane information DB 642, and sets the information. In addition, when there is a dimension (for example, a length of the boom) that cannot be specified only by selecting the model, the control unit 65 sets the dimension, based on a user operation. Here, for example, an information setting screen as illustrated in FIG. 12A is displayed on the display 620, and the user input is received, or various set information is displayed. In FIG. 12A, when the model is selected, options of front specifications (crane or tower) or shoe widths are read from the crane information DB 642, and information can be selected from the options.

Next, the control unit 65 acquires information related to the posture of the crane 20 from the crane 20 itself via the communication unit 63 (Step S12). Specifically, the control unit 65 acquires a boom angle, a jib angle, an inclination of the crane 20, and a height of the suspended load hook 28 which are measured by the boom angle sensor 322, the jib angle sensor 324, the inclination sensor 325, and the lift meter 326 of the crane 20, as information related to the posture of the crane 20. Furthermore, information related to a surrounding environment such as an inclination angle of the ground, a wind speed, and the weather may be acquired. The information may be acquired by providing a sensor for that purpose, or may be acquired from the network 130. Here, for example, an information setting screen as illustrated in FIG. 12B is displayed on the display 620, and various set information is displayed. In addition, in FIG. 12B, when the model is selected on the screen in FIG. 12A, options such as a type and a length of the boom are read from the crane information DB 642, and information such as the type and the length of the boom can be selected from the options.

The measured boom angle, jib angle, inclination of the crane 20, and height of the suspended load hook 28 may be displayed on the display device 332 of the crane 20, and the user may input a measurement value to the information terminal 60 while viewing the display.

Next, when the user presses a position registration button 704d on the top screen of the flight setting illustrated in FIG. 13A, the control unit 65 acquires information related to the position and the direction of the crane 20 via the positioning unit 421 and the direction sensor 422 of the moving body 40 (Step S13). Specifically, the moving body 40 is stopped (placed) at a predetermined position (for example, on a crawler) of the crane 20, and measures the position and the direction via the positioning unit 421 and the direction sensor 422 to acquire the information related to the position and the direction of the crane 20. Specifically, the moving body 40 is stopped at two locations on the crawler in the front-rear direction to acquire an azimuth angle from latitude and longitude information of the moving body 40 placed at these two locations. In this case, one moving body 40 may sequentially move to two locations to acquire the latitude and longitude information, or two moving bodies 40 may individually move to two locations to acquire the latitude and longitude information.

The crane 20 may be provided with the positioning unit and the direction sensor, and the position and the direction of the crane 20 may be measured by the positioning unit and the direction sensor. In addition, the position and the direction of the crane 20 may be acquired by a direct input (numerical value input) of the user. In addition, a distance measuring sensor may be mounted on the moving body 40, and the position of the crane 20 may be measured from the moving body 40 by the distance measuring sensor.

In this way, in Steps S11 to S13, disposition state data related to at least one of the structure, the posture, the position, and the direction of the crane 20 is acquired, and a disposition state of the crane 20 is specified by surrounding information obtained from an aerial photograph or map information and the disposition state data.

In addition, any one of the disposition state data of the crane 20 may be acquired from the crane 20. In addition, the disposition state data is not limited to data acquired by the above-described method, and data acquired in advance may be used. For example, when there is information on the disposition state acquired in advance by the crane 20 for derricking restriction or hoisting restriction, this information may be used. In this manner, input time and effort can be reduced.

In addition, it is desirable that the user is caused to check setting contents of the disposition state after the disposition state of the crane 20 is specified in Step S1. In this case, for example, the display 620 displays the direction of the crane 20 and a maximum planned flight line (outline of the flight path) on an aerial photograph map. The user is caused to check whether the flight path R of the moving body 40 or the crane 20 is located out of a predetermined site, or whether the position or the posture of the crane 20 is correct.

In addition, based on the data of the disposition state of the crane 20, the construction plan (BIM) at the actual work site, the map information of the jobsite, and the like, the control unit 65 calculates whether a flight space of the moving body 40 (interval between the crane 20 and the construction body 700, interval between the crane 20 and the partition wall 701, and interval between the crane 20 and the entry prohibited area) is insufficient on any surface side of the first to fourth surfaces 703a to 703d of the boom 24. The control unit 65 automatically determines the specific surface (first surface 703a and third surface 703c in the present embodiment) on which the moving body 40 cannot fly, and causes the display unit 62 to display the automatically determined specific surfaces (703a and 703c) (Step S2). In this manner, the worker can reliably recognize the specific surfaces (703a and 703c) without visually checking the actual work site.

Next, as illustrated in FIG. 9, the control unit 65 sets a flight condition (flight information) of the moving body 40 (Step S3).

In the present embodiment, a lower limit (closest approach distance) of a distance between the moving body 40 and the crane 20 during the flight is set as the flight condition of the moving body 40. The “distance” in this case is not particularly limited, but refers to a distance in a horizontal plane. Here, for example, an information setting screen as illustrated in FIGS. 13A and 13B is displayed on the display 620, and the user input is received, or various set information is displayed.

FIG. 13A illustrates the top screen of the flight setting, and a flight setting button 704a, a model specification registration button 704b, a flight information setting button 704c, a position registration button 704d, and a reset button 704e are displayed. In FIG. 13A, when the flight information setting button 704c is pressed by the user, an input screen of drone flight information (moving body flight information) in FIG. 13B is displayed on the display 620. On the input screen of the drone flight information illustrated in FIG. 13B, the user can input a height difference in a takeoff location, an imaging mode, a flight mode, surface selection for the single surface flight, and a distance to the crane. When the takeoff location is lower than a reference position of the crane (for example, a ground contact surface of the lower traveling body 21 of the crane 20), a negative numerical value is input as the height difference in the takeoff location (in the present embodiment, as the takeoff location, a state having no height difference is input). The imaging mode can be selected from a still image, an interval photograph, and a moving image, and is in a state where the interval photograph (photograph taken at every predetermined time) is selected. For the flight mode, any one of the single surface flight and the orbital flight can be selected, and it is in a state where the single surface flight is selected. The surface selection for the single surface flight is a screen for selecting a flight surface of the moving body 40, and any of a “front side” surface (first surface 703a), a “rear side” surface (third surface 703c), a “left side” surface (fourth surface 703d), and a “right side” surface (second surface 703b) can be selected. The screen shows a state where the “front side” surface (first surface 703a) is selected.

In the present embodiment, a flight path R is displayed for each selected surface (refer to FIGS. 11 and 15 to 17), and the flight path R can be set. That is, the periphery of the crane can be divided into a plurality of regions such as the “front side” surface (first surface 703a), the “rear side” surface (third surface 703c), the “left side” surface (fourth surface 703d), and the “right side” surface (second surface 703b), and the flight path R can be set for each region. The distance to the crane 20 can be input as an interval (interval in a horizontal direction) between the flying moving body 40 and the crane 20, and indicates a state where 2.5 meters (m) is input. On the screen in FIG. 13B, when the user completes the input of each item and presses an OK button, the screen display is switched to the top screen illustrated in FIG. 14A.

Next, as illustrated in FIG. 14A, when the flight setting button 704a is pressed on the top screen of the display 620, the flight route setting screen illustrated in FIG. 14B is displayed. The control unit 65 sets the flight path R of the moving body 40, based on the disposition state data of the crane 20 which is acquired in Step S1, the flight condition set in Step S3, and the drone flight information illustrated in FIG. 13B, and displays the flight path R on the display 620 (Step S4).

In the present embodiment, the flight path R on a single surface (front surface side) as illustrated in FIG. 11 is set, and the flight path R is displayed together with the whole crane 20 which is simply represented on the display 620. The flight path R indicates a case where the moving body 40 inspects a state of the crane 20 after flying from a lowest level to a highest level of the single surface (second surface 703b which is the right side surface), thereafter, the moving body 40 moving to the highest level flies each level toward the lowest level along the longitudinal direction of the boom 24, and the moving body 40 inspects the state of the crane 20.

The flight path R on the single surface includes a horizontal flight portion R1 and an upward-downward flight portion R2, and a case where the moving body 40 moves in a zigzag shape along the longitudinal direction of the boom 24 is illustrated as an example. In addition, in the flight path R, the moving body 40 may perform an outward flight in an odd-numbered level along the longitudinal direction of the boom from the lowest level to the highest level of the single surface, and thereafter, the moving body 40 may perform a return flight in an even-numbered level along the longitudinal direction of the boom 24 toward the lowest level. Here, in the flight path R, the horizontal flight portion R1 is set in a plurality of levels at a predetermined interval in a height direction of the crane 20. A vertical distance between the respective levels of the flight path R may be a predetermined default value, or may be set in a step (Step S3) of setting the flight condition of the moving body 40 illustrated in FIG. 9. In the flight path R, the path setting program 641 illustrated in FIG. 6 is changed. In this manner, without being limited to the flight path R illustrated in FIG. 11, the flight path R may be set by appropriately combining a case of a boom flight process of causing the moving body 40 to perform upward-downward and outward-return flights along the longitudinal direction of the boom 24, a case of a wire flight process of causing the moving body 40 to move along a linear member extending in the longitudinal direction of the pendant rope 229, the jib derricking rope 27, the main winding rope 256, or the like, and a case of temporarily stopping the moving body 40 at a specific location. The crane 20 can be efficiently detected in the upward-downward and outward-return flights by setting at least one of the outward flight and the return flight as the wire flight process and the other as the boom flight process. In addition, as the flight path R of the moving body 40, the flight path R in which the moving body 40 flies in a zigzag manner along an oblique strut of the boom 24 may be added. In addition, the flight path R of the moving body 40 can be a flight path in which the single surface flight and the orbital flight are combined by changing the path setting program 641 illustrated in FIG. 6. Here, the orbital flight is a flight of the moving body 40 turning once around the crane 20 along a horizontal plane, and the moving body 40 continuously flies four surfaces of the single surface along each level. As described above, when the flight path R of the moving body 40 is determined by combining the plurality of flight paths R, it is possible to more efficiently and accurately detect the state of the crane 20 disposed in a narrow work site.

In FIG. 11, a start button 623 and a stop button 624 for starting and stopping the flight of the moving body 40 are displayed at a left corner of the display 620 (in this case, one of the buttons that can be operated is actively displayed, and the other is non-actively displayed). In addition, a direction display unit 625 indicating the direction of the moving body 40 is displayed.

Next, as illustrated in FIG. 9, the control unit 65 determines whether or not an operation for changing the flight path R is performed (Step S5), and when it is determined that the operation is performed (Step S5: Yes), the flight path R is changed, based on a change operation thereof (Step S6). The control unit 65 proceeds to the process in Step S4 described above, sets the flight path R to the changed one, and causes the display 620 to display the changed flight path R.

In addition, when the control unit 65 determines that the operation of changing the flight path R is not performed in Step S5 (Step S5: No), the control unit 65 performs a confirmation process of the flight plan based on the user operation (Step S7).

Here, as illustrated in FIG. 14C, for example, the display 620 displays the number of images to be captured or a time for capturing the image set by the user as the flight plan.

Next, in FIG. 14C, when the flight plan of the display screen of the display 620 is confirmed by the user and the OK button is pressed, the control unit 65 displays a live view screen of the work site around the crane 20 on the display 620 as illustrated in FIG. 14D, and displays a surface on which the moving body 40 flies (Step S7), and when a start button is pressed on the display screen in FIG. 14E, the control unit 65 starts the flight of the moving body 40 along the flight path R set in Step S4 (Step S8).

The control unit 44 of the moving body 40 acquires captured image data and detection data during the flight of the moving body 40, and transmits diagnostic information data including the captured image data and the detection data to the information terminals 60 and 70 and the management server 50. The management server 50 performs a diagnostic process of determining the presence or absence of abnormality at a predetermined inspection location of the crane 20, based on the received diagnostic information data. The diagnostic process may be performed by the information terminals 60 and 70. In addition, during the automatic flight of the moving body 40, the flight of the moving body 40 can be temporarily stopped by the user operation. During the temporary stop of the moving body 40, the moving body 40 can be manually operated. In this manner, the inspection work for the crane 20 can be more thoroughly carried out. When the temporary stop is released, the moving body 40 automatically resumes the automatic flight from an interrupted position.

In this case, the control unit 65 causes the display 620 to display the image captured by the camera 41 in a live view.

Thereafter, when the flight of the moving body 40 along the flight path R is completed (Step S9), the control unit 65 returns the moving body 40 to a takeoff position (or stops the moving body 40 at a predetermined position other than the takeoff position), and completes the path setting process.

In addition, when the control unit 65 causes the display 620 to display the flight path R after the image is captured by the moving body 40 and an imaging point P (refer to FIG. 11) in the flight path R is selected by the user operation, the control unit 65 may cause the display 620 to display the captured image at the imaging point P.

As described above, detecting the state on a single surface (second surface 703b which is the right side surface) side of the crane 20 is completed. Subsequently, it is necessary to detect the state of the other three surface (fourth surface 703d, first surface 703a, and third surface 703c) sides of the crane 20.

When a “top screen return button” 705 located in an upper left portion is operated by the user on the screen illustrated in FIG. 14E, the control unit 65 displays the top screen of the flight setting illustrated in FIG. 13A. When all of the four surfaces are not completely detected (Step S10), the control unit 65 detects the state of the fourth surface (left side surface) 703d, which is a surface other than the specific surface, in the same manner as the detection of the state of the second surface (right side surface) 703b (Steps S3 to S9).

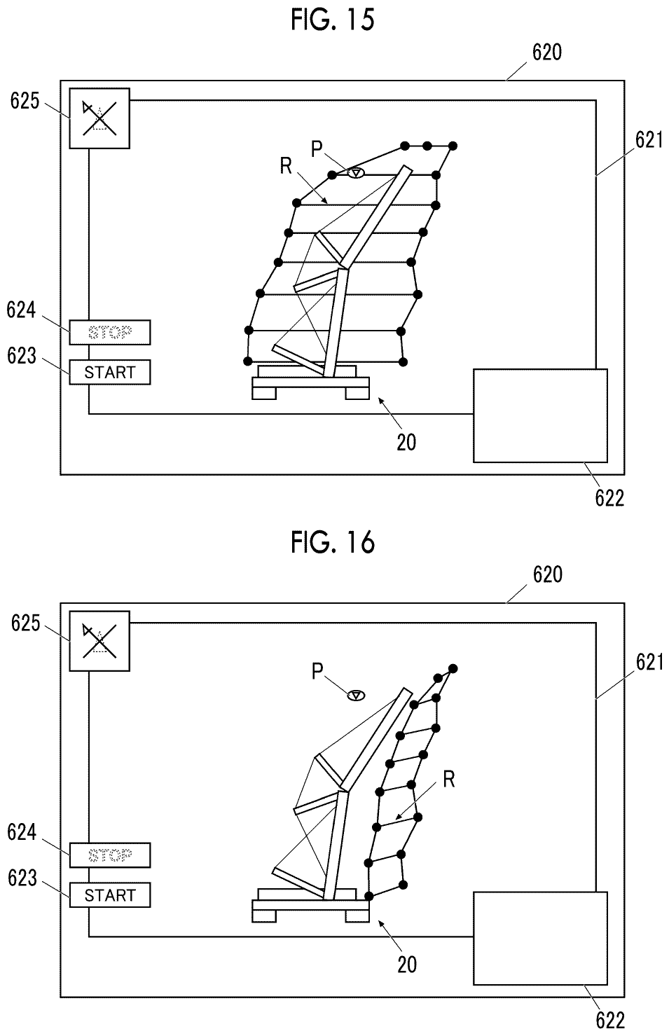

FIG. 15 is a view illustrating the flight path R of the moving body 40 on the fourth surface (left side surface) 703d of the crane 20, and the flight path R of the moving body 40 set in Step S4 is displayed together with the whole crane 20 which is simply represented on the display 620.

Here, a flight process in which the moving body 40 detects the state of the surfaces (second surface 703b and fourth surface 703d) other than the specific surface while flying as illustrated in FIGS. 11 and 15 will be referred to as a first flight process.

Next, the state of the crane 20 is detected on the first surface (front side surface) 703a which is the specific surface of the crane 20. Before detecting the state on the first surface 703a side which is the specific surface of the crane 20, the rotating platform 22 of the crane 20 is turned 90° in the clockwise direction in order to secure a space that enables the moving body 40 to fly. In this manner, the first surface 703a side and the third surface 703c side of the crane 20 directly face each other in the longitudinal direction (extension direction) of the passage 702, and the moving body 40 can automatically fly on the first surface 703a side and the third surface 703c side of the crane 20 in the same manner as the second surface 703b side and the fourth surface 703d side.

When the “top screen return button” 705 located in the upper left portion is operated by the user on the screen illustrated in FIG. 14E, the control unit 65 displays the top screen of the flight setting illustrated in FIG. 13A. When all of the four surfaces are not completely detected (Step S10), the control unit 65 detects the state on the first surface 703a side of the crane 20 in the same manner as the detection of the state on the second surface 703b side (Steps S3 to S9).

FIG. 16 is a view illustrating the flight path R of the moving body 40 on the first surface 703a side of the crane 20, and the flight path R of the moving body 40 set in Step S4 is displayed together with the whole crane 20 which is simply represented on the display 620. The control unit 65 causes the moving body 40 to automatically fly along the flight path R of the moving body 40 illustrated in FIG. 16, and detects the state on the first surface 703a side of the crane 20.

Next, the state on the third surface 703c side which is the specific surface of the crane 20 is detected. When the “top screen return button” 705 located in the upper left portion is operated by the user on the screen illustrated in FIG. 14E, the control unit 65 displays the top screen of the flight setting illustrated in FIG. 13A. When all of the four surfaces are not completely detected (Step S10), the control unit 65 detects the state on the third surface 703c side of the crane 20 in the same manner as the detection of the state on the first surface 703a side (Steps S3 to S9).

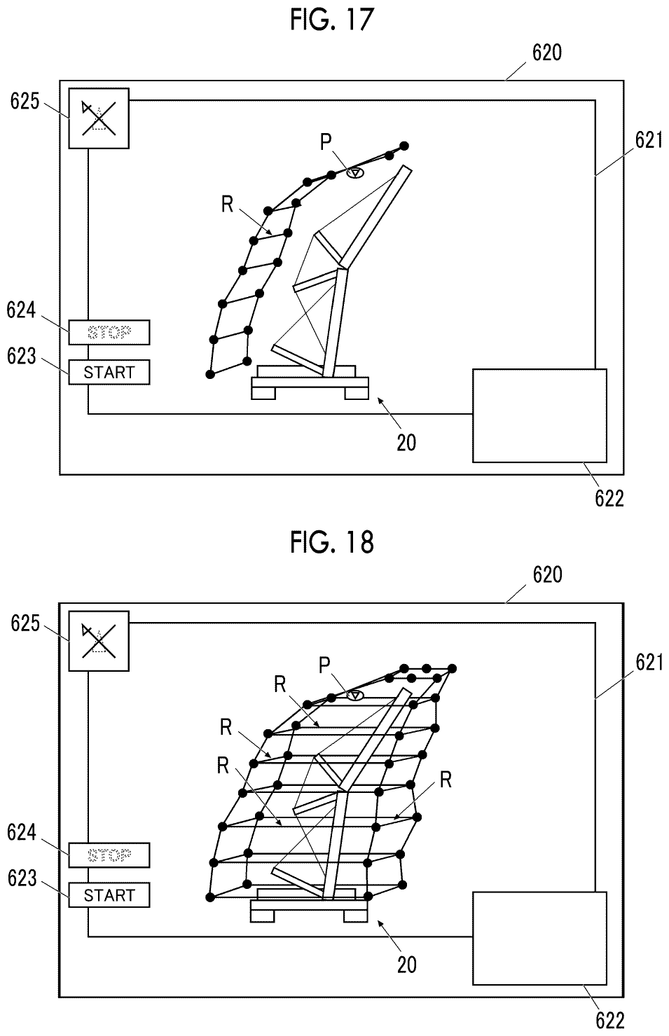

FIG. 17 is a view illustrating the flight path R of the moving body 40 on the third surface 703c side of the crane 20, and the flight path R of the moving body 40 set in Step S4 is displayed together with the whole crane 20 which is simply represented on the display 620. The control unit 65 causes the moving body 40 to automatically fly along the flight path R of the moving body 40 illustrated in FIG. 17, and detects the state on the third surface 703c side of the crane 20.

Here, a flight process in which the moving body 40 detects the state of the specific surfaces (first surface 703a and third surface 703c) while flying as illustrated in FIGS. 16 and 17 will be referred to as a second flight process.

FIG. 18 is a view three-dimensionally illustrating an example obtained by synthesizing the flight paths R in FIGS. 11, 15, 16, and 17. As illustrated in FIG. 18, when the flight paths R of the four surfaces are synthesized for each single surface, the flight paths R can be indicated as orbital paths orbiting around the crane 20. Even in the flight path R for each single surface, it is possible to detect the states of all of the four surfaces (first surface 703a to fourth surface 703d) of the crane 20. The moving body 40 individually flies in the state of the adjacent surfaces of the crane 20 (for example, the second surface 703b and the third surface 703c, the third surface 703c and the fourth surface 703d, the fourth surface 703d and the first surface 703a, and the first surface 703a and the second surface 703b). Therefore, it is not necessary that the flight paths R adjacent to the adjacent surfaces as illustrated in particular in FIG. 18 overlap each other. Therefore, a gap is provided between the adjacent flight paths R on the adjacent surfaces. However, the adjacent flight paths R may overlap each other. In addition, when the gap is provided between the adjacent flight paths R on the adjacent surfaces, for example, it is possible to minimize a possibility that the plurality of moving bodies 40 come into contact with each other when the moving bodies 40 fly simultaneously and fly on respectively different surfaces.

### Advantageous Effects of Present Embodiment

As described above, according to the present embodiment, when the boom 24 of the crane 20 includes four surfaces, after the first flight process of detecting the state of at least one surface excluding the specific surface of the four surfaces while the moving body 40 flies is performed, the crane 20 performs a turning, derricking, or traveling operation to secure a space in which the moving body 40 can fly around the specific surface. Thereafter, the second flight process of detecting the state of the specific surface while the moving body 40 flies is performed. As a result, according to the present embodiment, the inspection work for the crane 20 can be thoroughly carried out by the moving body 40 even in a narrow work site.

In addition, the flight method of the moving body 40 according to the present embodiment can be applied to a case of thoroughly inspecting the crane 20 as follows. A surface located in a direction in which GPS reception is difficult, a surface located in a direction of a structure in which magnetic or radio wave interference is strong, a surface located in an area interfering with an area in which another crane 20 is operated, and a surface located in a direction in which a strong wind blows are set as specific surfaces.

In addition, according to the present embodiment, the crane information DB 642 in which the plurality of models of the crane 20 and information related to a structure of each model are associated with each other is stored in advance.

Therefore, the user can easily acquire the information related to the structure of the crane 20 only by setting (inputting) the model information of the crane 20.

### Modification Example of Flight Path of Moving Body

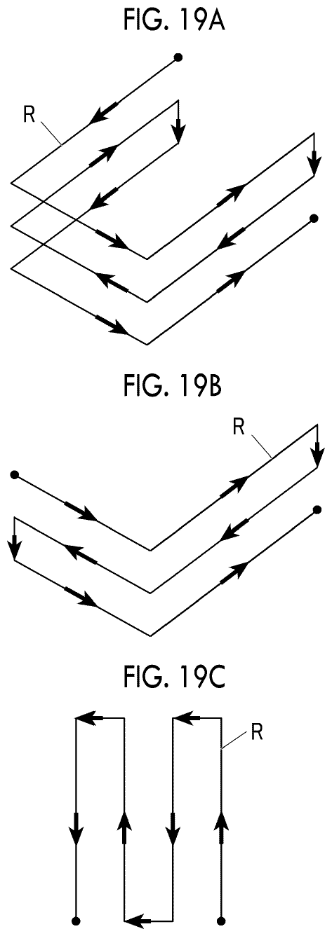

FIG. 19A is a view schematically illustrating a first modification example of the flight path R of the moving body (view in which the crane is omitted).

When three surfaces of the four surfaces of the boom are not the specific surfaces, and when the flight path R of the moving body illustrated in FIG. 19A is set to have a U-shape in the horizontal plane (same level), the moving body can fly to cross a plurality of surfaces (three surfaces which are not the specific surfaces). As a result, when the flight path R of the moving body illustrated in FIG. 19A is applied to a case of inspecting the crane, the three surface sides of the boom can be continuously inspected in a single stroke shape, and work efficiency can be improved, compared to when the moving body is reset for each single surface.

FIG. 19B is a view schematically illustrating a second modification example of the flight path R of the moving body (view in which the crane is omitted).

When two adjacent surfaces of the four surfaces of the boom are not the specific surfaces, and when the flight path R of the moving body illustrated in FIG. 19B is set to have an L-shape in the horizontal plane (same level), the moving body can fly to cross the plurality of surfaces (two surfaces which are not specific surfaces). That is, in at least one of the first flight process and the second flight process, the moving body 40 can fly along one of the two left-right surfaces (second surface 703b and fourth surface 703d), and thereafter, can subsequently fly along one of the two front-rear surfaces (first surface 703a and third surface 703c). As a result, when the flight path R of the moving body illustrated in FIG. 19B is applied to a case of inspecting the crane, the two surface sides of the boom can be continuously inspected in a single stroke shape, and the work efficiency can be improved, compared to when the moving body is reset for each single surface.

FIG. 19C is a view schematically illustrating a third modification example of the flight path R of the moving body (view in which the crane is omitted).

When one surface (single surface) of the boom is not the specific surface, the flight path R of the moving body illustrated in FIG. 19C is set to have a single stroke shape such that flight path portions directed in the longitudinal direction (up-down direction in FIG. 19C) of the boom are different between the outward flight and the return flight. When the flight path R of the moving body is applied to the case of inspecting the crane, the flight path portions directed in the longitudinal direction of the boom do not overlap. Therefore, the work efficiency is improved.

### Other

In FIG. 9, in Step S1 of the path setting process, disposition state data of the crane 20 may be acquired from the crane 20 at a predetermined timing, and in Step S3 subsequent thereto, a movement path of the moving body 40 may be set (updated), based on the disposition state data acquired at the predetermined timing. That is, the processes in Steps S1 and S3 may be performed at any time (for example, at a regular time interval), or may be performed at a timing at which the disposition state of the crane 20 is changed. In this manner, the flight path can be suitably set (changed) even during the operation of the crane 20.

Furthermore, the path setting at the predetermined timing may be performed during the flight of the moving body 40 in Step S8.

In addition, in the above-described embodiment, the path setting process is performed by the path setting program 641 in the information terminal 60. However, the path setting process can be performed as long as the device can acquire the disposition state data of the crane 20 and has arithmetic capability. Therefore, the information terminal according to the present invention includes the crane 20 itself and the moving body 40, in addition to the information terminals 60 and 70 and the management server 50. Similarly, the processing unit that performs the process of performing the inspection on the crane 20 includes the crane 20 itself and the moving body 40, in addition to the information terminals 60 and 70 and the management server 50. In addition, the path setting unit according to the present invention may be different from the processing unit. For example, the processing unit may be the management server 50, and the path setting unit may be the information terminals 60 and 70.

In addition, in the above-described embodiment, a mobile tower crane has been described as an example of the crane 20. However, the present invention is not limited thereto, and in addition to other mobile cranes such as a wheel crane, a truck crane, a rough terrain crane, and an all-terrain crane, the present invention is applicable to various cranes such as a tower crane, an overhead crane, a jib crane, a retractable crane, a stacker crane, a portal crane, and an unloader.

Furthermore, the present invention is not limited to the crane provided with the suspended load hook, and is also applicable to a crane that suspends attachments such as a magnet and an earth drill bucket.

In addition, in the above-described embodiment, the crane 20 is the inspection target of the moving body 40. However, the present invention is suitably applicable to various inspection targets whose disposition state varies. In addition to the crane, this inspection target includes amusement rides such as a Ferris wheel and a roller coaster, a windmill, an excavator, an airplane, and a ship. The present invention is also applicable to an inspection of an existing building.

In addition, the present invention is not limited to those which perform an inspection (diagnostic process) based on an image, and is also applicable to imaging which is not intended for the inspection, for example, when a captured image is displayed to an inspection operator.

Alternatively, details in the above-described embodiment can be changed as appropriate within the scope not departing from the concept of the invention.

The disclosure of the specification, the drawings, and the abstract which are included in Japanese Patent Application No. 2022-209919 filed on Dec. 27, 2022 is incorporated herein by reference in its entirety.

The present invention can be used for a flight method of a moving body, a flight setting device, and a program.

It should be understood that the invention is not limited to the above-described embodiment, but may be modified into various forms on the basis of the spirit of the invention. Additionally, the modifications are included in the scope of the invention.

What is claimed is:

1. A flight method for a moving body including a detection unit, the method comprising:
a first flight process of flying while the detection unit detects a surface of a normal portion other than a specific portion of a crane; and
a second flight process of flying while the detection unit detects a surface of the specific portion of the crane in a state where at least one of a position, a turning angle, and a boom angle is different, compared to the first flight process.

2. The flight method for a moving body according to claim 1,
wherein the second flight process is performed after the first flight process is performed and after the crane performs at least one operation of traveling, turning, and boom derricking.

3. The flight method for a moving body according to claim 1,
wherein, when two surfaces parallel to a front-rear direction of a rotating platform of the crane and located on both outer sides in a left-right direction of the rotating platform are defined as two left-right surfaces, and two surfaces perpendicular to the front-rear direction of the rotating platform and located on both outer sides in the front-rear direction of the rotating platform are defined as two front-rear surfaces, and
when the moving body is assumed to be located on a specific surface of four surfaces including the two left-right surfaces and the two front-rear surfaces, a portion detectable by the detection unit of the moving body is the specific portion.

4. The flight method for a moving body according to claim 1,
wherein in at least one of the first flight process and the second flight process, the moving body flies along one of two front-rear surfaces after flying along one of two left-right surfaces.

5. The flight method for a moving body according to claim 1,
wherein at least one of the first flight process and the second flight process includes a boom flight process in which the moving body flies along a longitudinal direction of a boom, and a wire flight process in which the moving body flies along a wire rope disposed along the boom.

6. The flight method for a moving body according to claim 1
wherein the detection unit is a camera that is supported to be directed from a machine body of the moving body in a predetermined direction.

7. A flight setting device for performing settings related to a flight of a moving body including a detection unit, the device comprising:
a flight path setting unit that sets a flight path of the moving body; and
an information transmission unit that transmits flight information for causing the moving body to fly along the flight path set by the flight path setting unit to the moving body,
wherein the flight path setting unit is configured to set the flight path for each region of a plurality of regions obtained by dividing a periphery of a crane.

8. The flight setting device according to claim 7,
wherein the flight information of the moving body is a distance between the moving body and the crane during the flight.

9. The flight setting device according to claim 7, further comprising:
an input unit that includes a touch panel and outputs an input signal corresponding to operation contents of a user operating the touch panel to the flight path setting unit;
a display unit that includes a display and displays information on the display, based on a display signal input from the flight path setting unit; and
a storage unit that stores a program and data, and serves as a work region of the flight path setting unit.

10. The flight setting device according to claim 9,
wherein the flight path setting unit reads the program from the storage unit in response to an operation signal input from the input unit, performs a predetermined process in accordance with the program, temporarily stores a process result of the predetermined process in the storage unit, and appropriately outputs the process result to the display unit.

11. The flight setting device according to claim 7,
wherein the information transmission unit is configured to perform data communication with the crane, the moving body, and a management server via a network.

12. The flight setting device according to claim 7,
wherein, when two surfaces parallel to a front-rear direction of a turning body of the crane and located on both outer sides in a left-right direction of the turning body are defined as two left-right surfaces, and two surfaces perpendicular to the front-rear direction of the turning body and located on both outer sides in the front-rear direction of the turning body are defined as two front-rear surfaces, the flight path setting unit is configured to set the flight path for one or more surfaces out of the four surfaces including the two left-right surfaces and the two front-rear surfaces.

13. A non-transitory computer readable medium storing a program for performing settings related to a flight of a moving body including a detection unit, the program when executed by a computer, causing the computer to execute:
a flight path setting step of setting a flight path of the moving body; and
an information transmission step of transmitting flight information for causing the moving body to fly along the flight path set in the flight path setting step to the moving body,
wherein, in the flight path setting step, the flight path is settable for each region of a plurality of regions obtained by dividing a periphery of a crane.
